(19) United States
(12) Patent Application Publication
(10) Pub. No.: US 2024/0378582 A1
(43) Pub. Date: Nov. 14, 2024

(54) METHODS, SYSTEMS, APPARATUSES, AND DEVICES OF FACILITATING PRESELLING AND PROVISIONING OF ASSETS USING NONFUNGIBLE TOKENS

(71) Applicants: Arben Kane, Kula, HI (US); Theodore Aaron Einstein, Boca Raton, FL (US)

(72) Inventors: Arben Kane, Kula, HI (US); Theodore Aaron Einstein, Boca Raton, FL (US)

(21) Appl. No.: 18/772,285

(22) Filed: Jul. 15, 2024

(30) Foreign Application Priority Data
Feb. 23, 2023 (WO) PCT/US23/13898

(51) Int. Cl. G06Q 20/28; G06Q 20/38

(52) U.S. Cl. CPC G06Q 20/28; G06Q 20/389

(57) ABSTRACT

The present disclosure provides a method of facilitating preselling and provisioning of assets using nonfungible tokens. Further, the method may include generating a purchase order for the user based on the selection of the asset. Further, the purchase order includes a price information of the asset and a prompt requesting a payment for the asset. Further, the method may include processing a transaction for the asset using the user payment data and the purchase order. Further, the method may include generating an asset nonfungible token data of the asset based on the processing. Further, the asset nonfungible token guarantees the user of the provisioning of the asset up for a sale of the asset.

### CROSS-REFERENCE TO RELATED APPLICATION

This application claims the benefit of international application No. PCT/US23/13898 filed on 25 Feb. 2023 and titled “METHODS, SYSTEMS, APPARATUSES, AND DEVICES OF FACILITATING PRESELLING AND PROVISIONING OF ASSETS USING NONFUNGIBLE TOKENS” which in turn claims the benefit of the U.S. Provisional Patent Application No. 63/314,374, titled “METHODS AND SYSTEMS FOR FACILITATING SELLING ASSETS USING NONFUNGIBLE TOKENS”, filed 26 Feb. 2022, which is incorporated by reference herein in its entirety.

### FIELD OF DISCLOSURE

Generally, the present disclosure relates to the field of data processing. More specifically, the present disclosure relates to methods, systems, apparatuses, and devices of facilitating preselling and provisioning of assets using nonfungible tokens.

### BACKGROUND

The field of data processing is technologically important to several industries, business organizations, and/or individuals.

A non-fungible token (NFT) is a non-interchangeable unit of data stored on a blockchain, a form of digital ledger, that can be sold and traded. Further, NFT ledgers claim to provide a public certificate of authenticity or proof of ownership. Further, during a pre-sale of limited-edition assets (such as products, tickets, services, shoes, etc.), buyers usually didn't get a chance to buy the assets due to the unavailability of stocks or the limited duration of the pre-sale period.

Existing techniques for facilitating preselling and provisioning of assets are deficient with regard to several aspects. For instance, current technologies do not use non-fungible tokens for pre-selling the assets before launching the assets. Further, current technologies do not facilitate capturing trades of the assets in a secondary market. Furthermore, current technologies do not facilitate discovering a price of the assets in the secondary market.

Therefore, there is a need for improved methods, systems, apparatuses, and devices of facilitating preselling and provisioning of assets that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of facilitating preselling and provisioning of assets using nonfungible tokens. Further, the method may include receiving, using a communication device, a request for purchasing the assets from one or more user devices associated with one or more users. Further, the method may include transmitting, using the communication device, an asset data of a number of assets available to be pre-sold to the one or more users to the one or more user devices. Further, the method may include receiving, using the communication device, one or more selections of one or more assets from the number of assets from the one or more user devices. Further, the method may include generating, using a processing device, one or more purchase orders for the one or more users based on the one or more selections of the one or more assets. Further, the one or more purchase orders may include one or more price information associated with one or more prices of the one or more assets and one or more prompts requesting one or more payments for the one or more assets. Further, the method may include transmitting, using the communication device, the one or more purchase orders to the one or more user devices. Further, the method may include receiving, using the communication device, one or more user payment data for the one or more payments of the one or more assets from the one or more user devices. Further, the method may include processing, using the processing device, a transaction for the one or more assets using the one or more user payment data and the one or more purchase orders. Further, the method may include generating, using the processing device, one or more asset nonfungible token data corresponding to one or more asset nonfungible tokens of the one or more assets based on the processing. Further, the one or more asset nonfungible tokens guarantee the one or more users of the provisioning of the one or more assets up to a launch date for a sale of the one or more assets. Further, the method may include transmitting, using the communication device, the one or more asset nonfungible tokens to the one or more user devices. Further, the method may include storing, using a storage device, the one or more asset nonfungible token data to a distributed ledger.

The present disclosure provides a system for facilitating preselling and provisioning of assets using nonfungible tokens. Further, the system may include a communication device. Further, the communication device may be configured for receiving a request for purchasing the assets from one or more user devices associated with one or more users. Further, the communication device may be configured for transmitting an asset data of a number of assets available to be pre-sold to the one or more users to the one or more user devices. Further, the communication device may be configured for receiving one or more selections of one or more assets from the number of assets from the one or more user devices. Further, the communication device may be configured for transmitting one or more purchase orders to the one or more user devices. Further, the communication device may be configured for receiving one or more user payment data for the one or more payments of the one or more assets from the one or more user devices. Further, the communication device may be configured for transmitting one or more asset nonfungible tokens to the one or more user devices. Further, the system may include a processing device communicatively coupled with the communication device. Further, the processing device may be configured for generating the one or more purchase orders for the one or more users based on the one or more selections of the one or more assets. Further, the one or more purchase orders include one or more price information associated with one or more prices of the one or more assets and one or more prompts requesting one or more payments for the one or more assets. Further, the processing device may be configured for processing a transaction for the one or more assets using the one or more user payment data and the one or more purchase orders. Further, the processing device may be configured for generating one or more asset nonfungible token data corresponding to the one or more asset nonfungible tokens of the one or more assets based on the processing. Further, the one or more asset nonfungible tokens guarantee the one or more users of the provisioning of the one or more assets up to a launch date for a sale of the one or more assets. Further, the system may include a storage device communicatively coupled with the processing device. Further, the storage device may be configured for storing the one or more asset nonfungible token data to a distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3A illustrates a flowchart of a method 300 of facilitating preselling and provisioning of assets using nonfungible tokens, in accordance with some embodiments.

FIG. 3B illustrates a continuation of the flowchart of the method 300 of facilitating preselling and provisioning of assets using nonfungible tokens, in accordance with some embodiments.

FIG. 4 illustrates a flowchart of a method 400 of facilitating preselling and provisioning of assets using nonfungible tokens, in accordance with some embodiments.

FIG. 5A illustrates a flowchart of a method 500 of facilitating preselling and provisioning of assets using nonfungible tokens, in accordance with some embodiments.

FIG. 5B illustrates a continuation of the flowchart of the method 500 of facilitating preselling and provisioning of assets using nonfungible tokens, in accordance with some embodiments.

FIG. 6 illustrates a flowchart of a method 600 of facilitating preselling and provisioning of assets using nonfungible tokens, in accordance with some embodiments.

FIG. 7 illustrates a flowchart of a method 700 of facilitating preselling and provisioning of assets using nonfungible tokens, in accordance with some embodiments.

FIG. 8 illustrates a flowchart of a method 800 of facilitating preselling and provisioning of assets using nonfungible tokens, in accordance with some embodiments.

FIG. 9 illustrates a flowchart of a method 900 of facilitating preselling and provisioning of assets using nonfungible tokens, in accordance with some embodiments.

FIG. 10 illustrates a block diagram of a system 1000 of facilitating preselling and provisioning of assets using nonfungible tokens, in accordance with some embodiments.

FIG. 11 illustrates a block diagram of the system 1000 of facilitating preselling and provisioning of assets using nonfungible tokens, in accordance with some embodiments.

FIG. 12 is a flow chart of a method 1200 for facilitating selling assets using non-fungible tokens, in accordance with some embodiments.

FIG. 13 is a flow chart of a method 1300 for facilitating selling assets using non-fungible tokens, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for facilitating preselling and provisioning of assets using nonfungible tokens. Further, the disclosed system may be configured for pre-selling assets (such as products, services, tickets, etc.) before the launch using NFTs. Further, the disclosed system may allow buyers to purchase NFTs which may guarantee that the buyers receive assets associated with the NFTs on or before the launch date. Further, the disclosed system may allow buyers worldwide to purchase the NFTs (at a markup price). Further, the disclosed system may be configured for capturing trades of the NFTs (and the assets or associated assets) in the secondary market. This may help in price discovery.

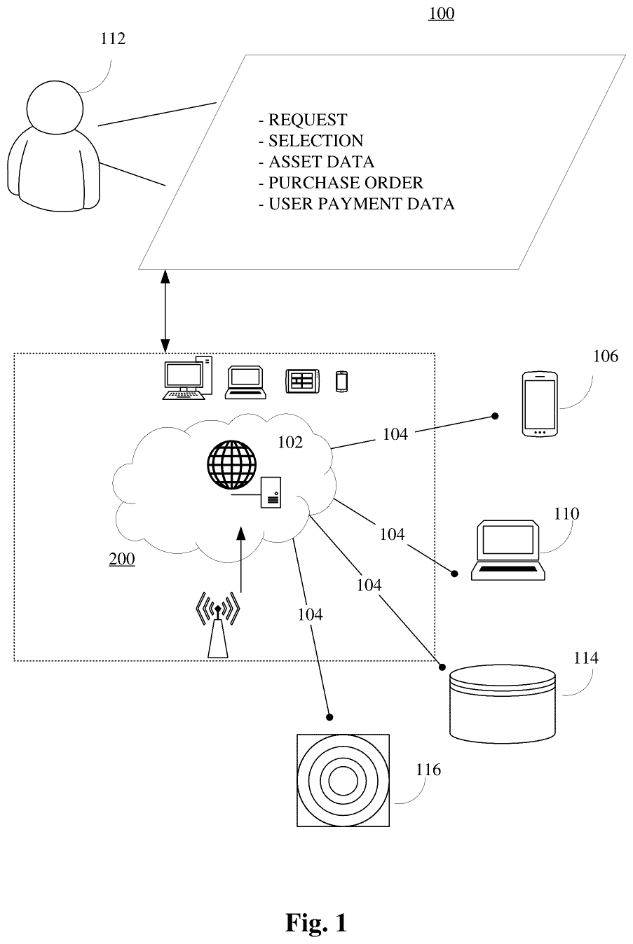

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

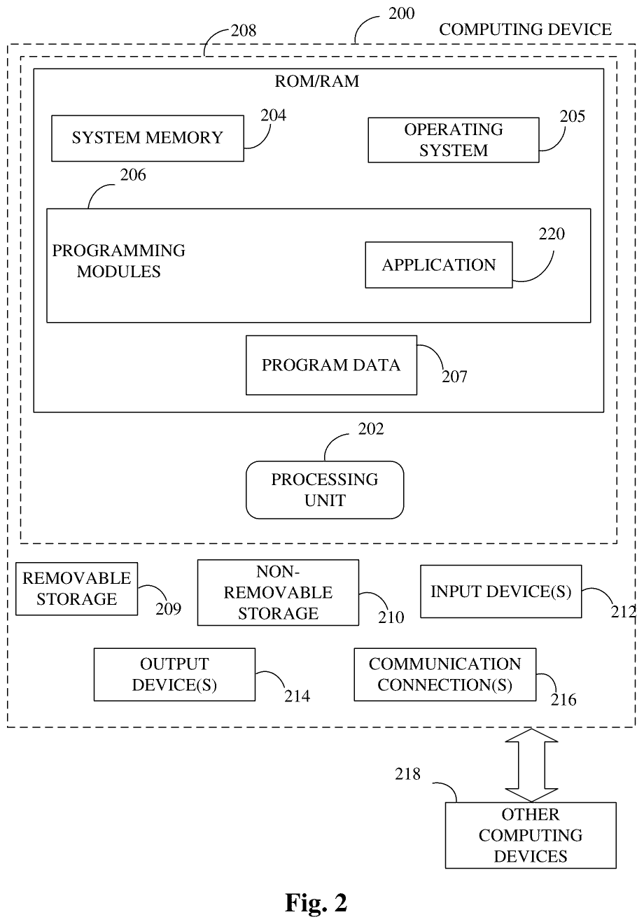

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

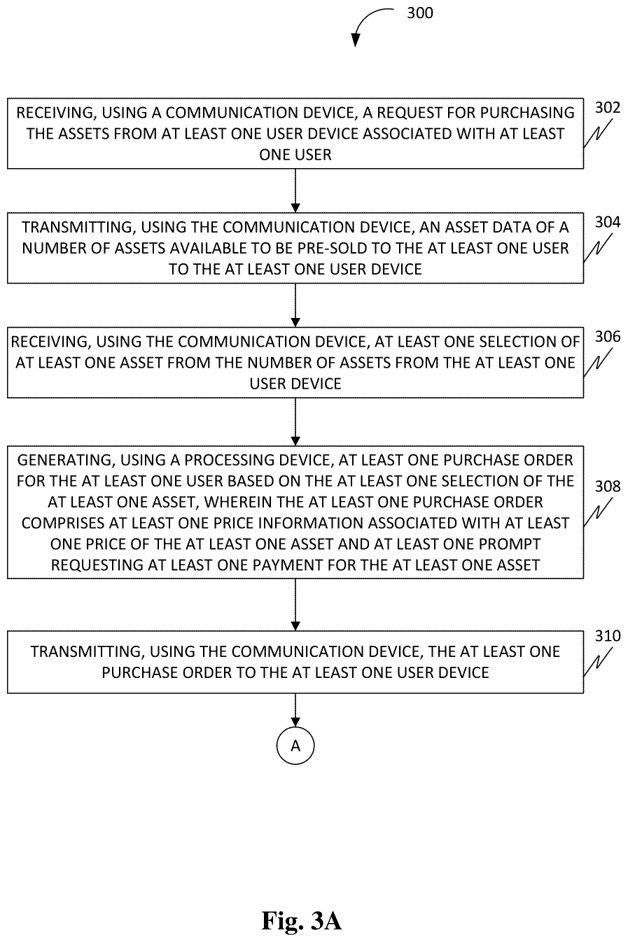

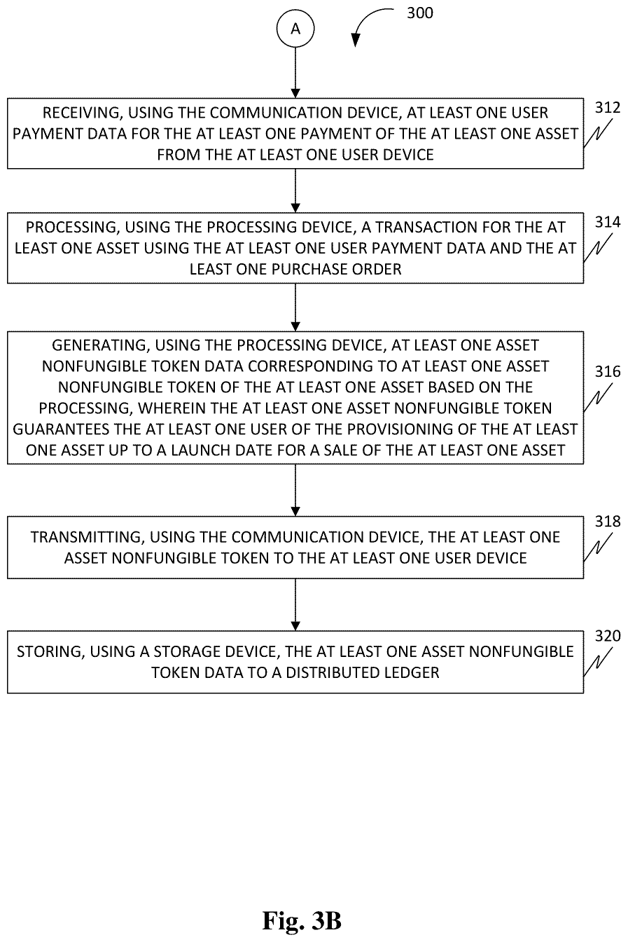

FIG. 3A and FIG. 3B illustrate a flowchart of a method 300 of facilitating preselling and provisioning of assets using nonfungible tokens, in accordance with some embodiments.

Accordingly, the method 300 may include a step 302 of receiving, using a communication device 1002, a request for purchasing the assets from one or more user devices (such as one or more user devices 1102) associated with one or more users. Further, the assets may include tangible objects and intangible objects. Further, the tangible objects may include products, physical tickets, items, apparel (shoes), etc. Further, the intangible objects may include services, computer generated tickets, software, intellectual properties, etc. Further, the one or more user devices may include computing devices, client devices, etc. Further, the one or more users may include individuals, institutions, organizations, etc.

Further, the method 300 may include a step 304 of transmitting, using the communication device 1002, an asset data of a number of assets available to be pre-sold to the one or more users to the one or more user devices. Further, the asset data may include information such as date of launch, specifications, markup price, identifiers, etc. of the number of assets. Further, the asset data may include a presale data.

Further, the method 300 may include a step 306 of receiving, using the communication device 1002, one or more selections of one or more assets from the number of assets from the one or more user devices. Further, the one or more selections may include indications of the one or more assets. Further, the one or more assets may include tangible objects and intangible objects.

Further, the method 300 may include a step 308 of generating, using a processing device 1004, one or more purchase orders for the one or more users based on the one or more selections of the one or more assets. Further, the one or more purchase orders may include one or more price information associated with one or more prices of the one or more assets and one or more prompts requesting one or more payments for the one or more assets. Further, the one or more prompts may include requests to the one or more users for making the one or more payments for the one or more assets.

Further, the method 300 may include a step 310 of transmitting, using the communication device 1002, the one or more purchase orders to the one or more user devices.

Further, the method 300 may include a step 312 of receiving, using the communication device 1002, one or more user payment data for the one or more payments of the one or more assets from the one or more user devices. Further, the one or more user payment data may include information about bank accounts, digital wallets, etc. of the one or more users. Further, the one or more user payment data may include payment details associated with one or more payment modes. Further, the one or more payment modes may include NEFT, IMPS, UPI, credit card payment, debit card payment, etc. Further, the one or more user payment data may include bank account credentials, credit card credentials, debit card credentials, UPI id credentials, etc. of the one or more users.

Further, the method 300 may include a step 314 of processing, using the processing device 1004, a transaction for the one or more assets using the one or more user payment data and the one or more purchase orders.

Further, the method 300 may include a step 316 of generating, using the processing device 1004, one or more asset nonfungible token data corresponding to one or more asset nonfungible tokens (NFTs) of the one or more assets based on the processing. Further, the one or more asset nonfungible tokens represent the one or more assets. Further, the one or more asset nonfungible token data may include provenance, ownership, change in the ownership, information (identifiers, date of launch, specifications, markup price, etc.) of the one or more assets, asset nonfungible tokens' identifiers, etc. Further, the one or more asset nonfungible tokens may guarantee the one or more users of the provisioning of the one or more assets up to a launch date for a sale of the one or more assets.

Further, the method 300 may include a step 318 of transmitting, using the communication device 1002, the one or more asset nonfungible tokens to the one or more user devices.

Further, the method 300 may include a step 320 of storing, using a storage device 1006, the one or more asset nonfungible token data to a distributed ledger. Further, the distributed ledger may be associated with a blockchain.

In some embodiments, the method 300 may further include generating, using the processing device 1004, the one or more asset nonfungible tokens based on the processing and the one or more selections of the one or more assets. Further, the generating of the one or more asset nonfungible tokens may include minting the one or more asset nonfungible tokens based on the processing and the one or more selections of the one or more assets. Further, the generating of the one or more asset nonfungible token data may be based on the generating of the one or more asset nonfungible tokens.

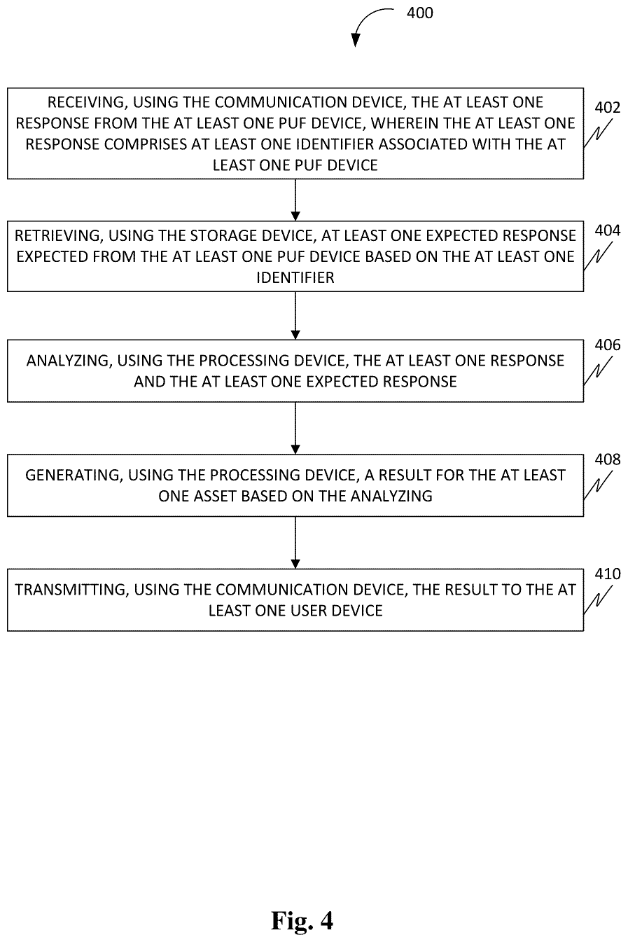

FIG. 4 illustrates a flowchart of a method 400 of facilitating preselling and provisioning of assets using nonfungible tokens, in accordance with some embodiments.

Further, in some embodiments, the one or more assets may include at least one physically unclonable function (PUF) device (such as one or more PUF device 1104). Further, the one or more PUF devices may be configured for generating one or more responses based on one or more stimuli (physical stimuli) to the one or more PUF devices. Further, the method 400 may include a step 402 of receiving, using the communication device 1002, the one or more responses from the one or more PUF devices. Further, the one or more responses may include one or more identifiers associated with the one or more PUF devices.

Further, the method 400 may include a step 404 of retrieving, using the storage device 1006, one or more expected responses expected from the one or more PUF devices based on the one or more identifiers.

Further, the method 400 may include a step 406 of analyzing, using the processing device 1004, the one or more responses and the one or more expected responses.

Further, the method 400 may include a step 408 of generating, using the processing device 1004, a result for the one or more assets based on the analyzing.

Further, the method 400 may include a step 410 of transmitting, using the communication device 1002, the result to the one or more user devices.

In some embodiments, the analyzing further includes comparing the one or more responses and the one or more expected responses using one or more machine learning models. Further, the one or more machine learning models may be trained for matching responses and expected responses with a degree of certainty. Further, the method 400 includes determining, using the processing device 1004, a degree of match between the one or more responses and the one or more expected responses based on the comparing. Further, the degree of match corresponds to the degree of certainty. Further, the degree of match may be a level of confidence in the authenticity of the one or more assets. Further, the generating of the result may be based on the determining of the degree of match.

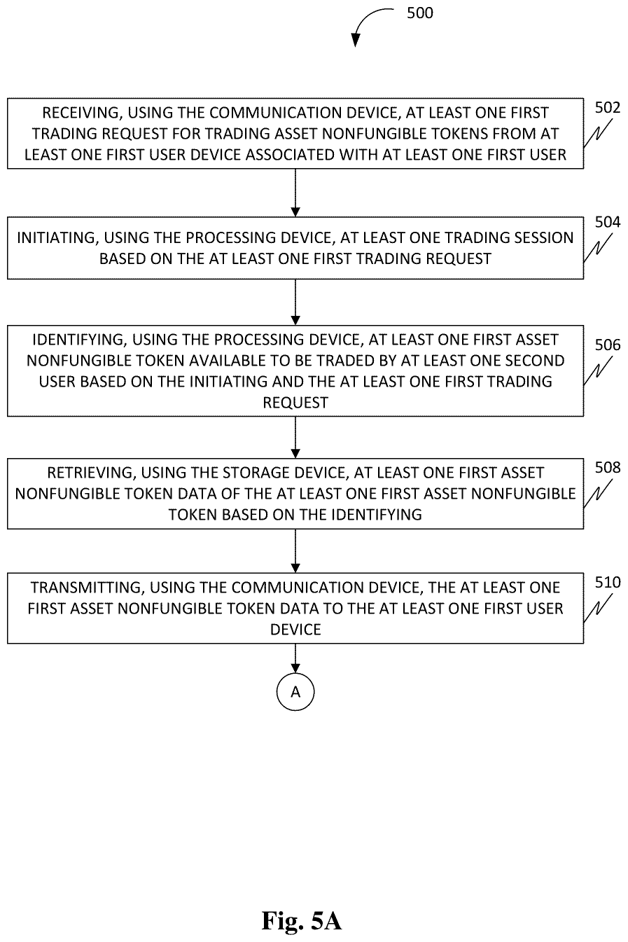

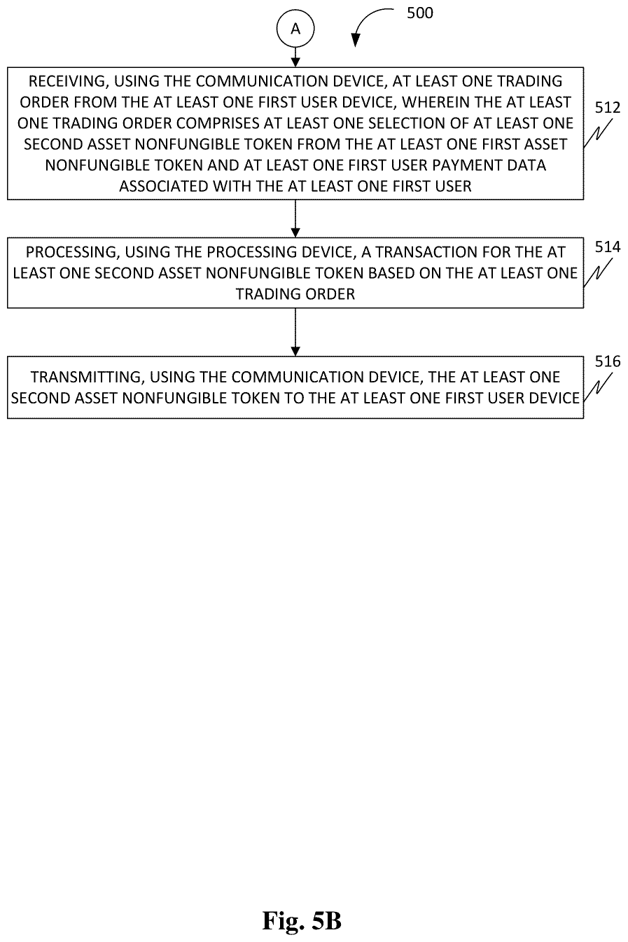

FIG. 5A and FIG. 5B illustrate a flowchart of a method 500 of facilitating preselling and provisioning of assets using nonfungible tokens, in accordance with some embodiments.

Further, in some embodiments, the method 500 may include a step 502 of receiving, using the communication device 1002, one or more first trading requests for trading asset nonfungible tokens from one or more first user devices (such as one or more first user devices 1106) associated with one or more first users. Further, the trading of the asset nonfungible tokens may be facilitated in secondary markets. Further, the one or more first user devices may include computing devices, client devices, etc. Further, the one or more first users may include individuals, institutions, organizations, etc.

Further, the method 500 may include a step 504 of initiating, using the processing device 1004, one or more trading sessions based on the one or more first trading requests.

Further, the method 500 may include a step 506 of identifying, using the processing device 1004, one or more first asset nonfungible tokens available to be traded by one or more second users based on the initiating and the one or more first trading requests. Further, the one or more second users may include individuals, institutions, organizations, etc.

Further, the method 500 may include a step 508 of retrieving, using the storage device 1006, one or more first asset nonfungible token data of the one or more first asset nonfungible tokens based on the identifying. Further, the one or more first asset nonfungible token data may include provenance, ownership, change in the ownership, trading price, information (identifiers, date of launch, specifications, markup price, first asset nonfungible tokens' identifiers, etc.) of the one or more first assets, etc.

Further, the method 500 may include a step 510 of transmitting, using the communication device 1002, the one or more first asset nonfungible token data to the one or more first user devices.

Further, the method 500 may include a step 512 of receiving, using the communication device 1002, one or more trading orders from the one or more first user devices. Further, the one or more trading orders may include one or more selections of one or more second asset nonfungible tokens from the one or more first asset nonfungible tokens and one or more first user payment data associated with the one or more first users.

Further, the method 500 may include a step 514 of processing, using the processing device 1004, a transaction for the one or more second asset nonfungible tokens based on the one or more trading orders.

Further, the method 500 may include a step 516 of transmitting, using the communication device 1002, the one or more second asset nonfungible tokens to the one or more first user devices.

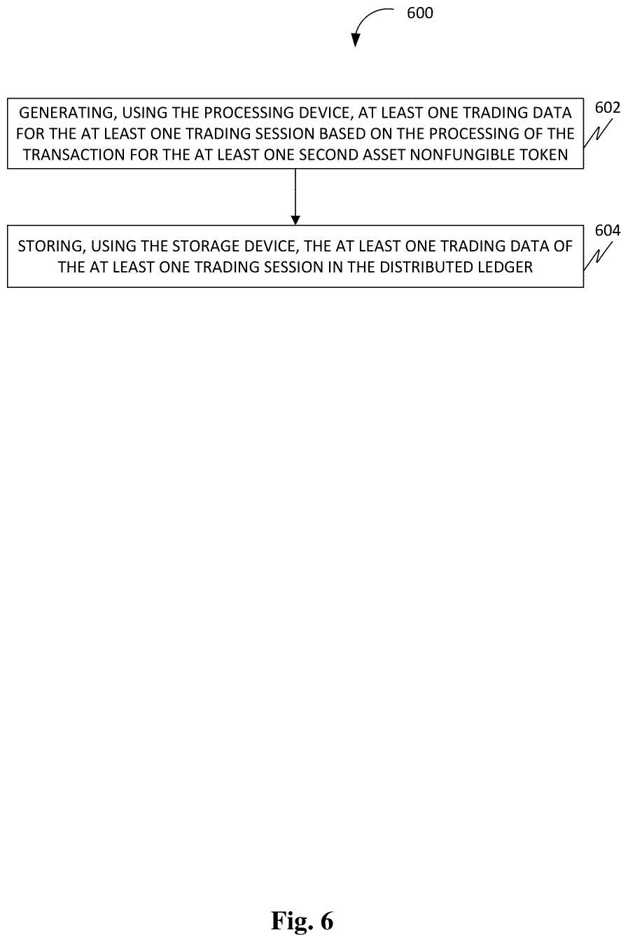

FIG. 6 illustrates a flowchart of a method 600 of facilitating preselling and provisioning of assets using nonfungible tokens, in accordance with some embodiments.

Further, the method 600 may include a step 602 of generating, using the processing device 1004, one or more trading data for the one or more trading sessions based on the processing of the transaction for the one or more second asset nonfungible tokens. Further, the one or more trading data may include first user's identifiers, second user's identifiers, second asset nonfungible token's identifiers, trading prices of the one or more second asset nonfungible tokes, etc.

Further, the method 600 may include a step 604 of storing, using the storage device 1006, the one or more trading data of the one or more trading sessions in the distributed ledger.

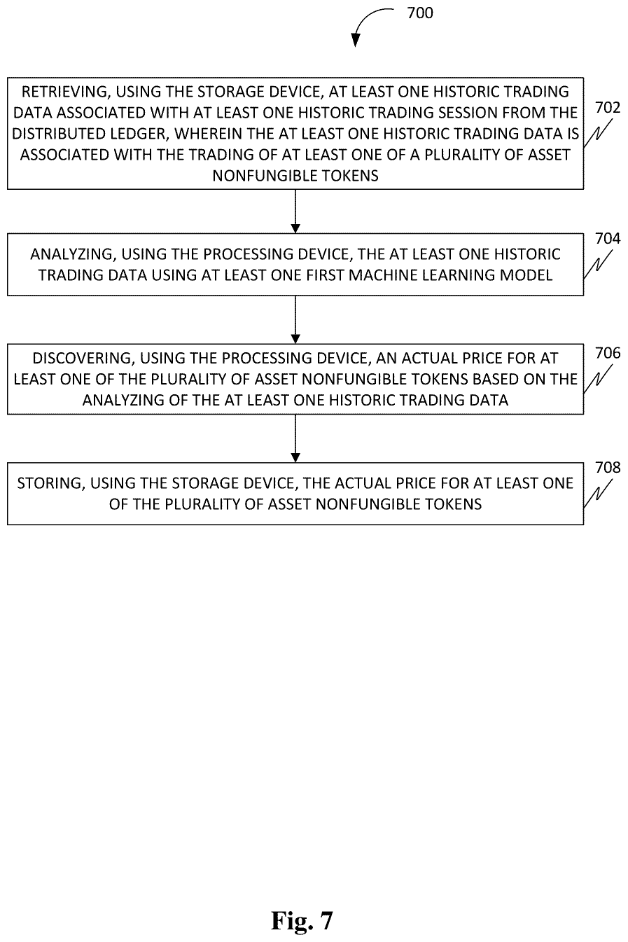

FIG. 7 illustrates a flowchart of a method 700 of facilitating preselling and provisioning of assets using nonfungible tokens, in accordance with some embodiments.

Further, in some embodiments, the method 700 may include a step 702 of retrieving, using the storage device 1006, one or more historic trading data associated with one or more historic trading sessions from the distributed ledger. Further, the one or more historic trading data may be associated with the trading of one or more of two or more asset nonfungible tokens.

Further, the method 700 may include a step 704 of analyzing, using the processing device 1004, the one or more historic trading data using one or more first machine learning models. Further, the one or more first machine learning models may be trained in performing price discovery for the asset nonfungible tokens representing the assets.

Further, the method 700 may include a step 706 of discovering, using the processing device 1004, an actual price for one or more of the two or more asset nonfungible tokens based on the analyzing of the one or more historic trading data.

Further, the method 700 may include a step 708 of storing, using the storage device 1006, the actual price for one or more of the two or more asset nonfungible tokens.

In some embodiments, the two or more asset nonfungible tokens may include the one or more second asset nonfungible tokens. Further, the method 700 includes analyzing, using the processing device 1004, the one or more trading data associated with the one or more trading sessions using the one or more first machine learning models. Further, the discovering of the actual price for one or more of the two or more asset nonfungible tokens may be based on the analyzing of the one or more trading data.

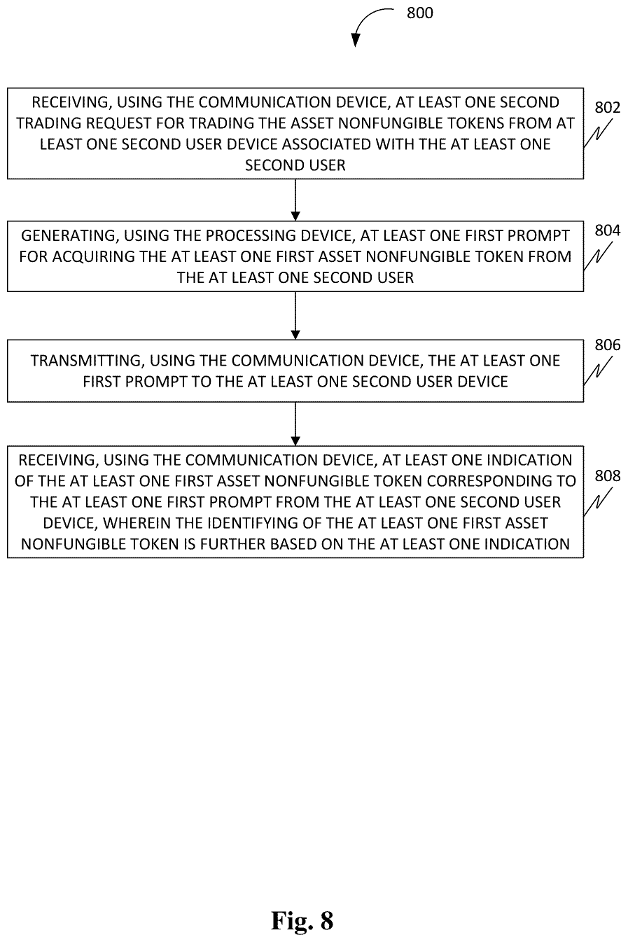

FIG. 8 illustrates a flowchart of a method 800 of facilitating preselling and provisioning of assets using nonfungible tokens, in accordance with some embodiments.

Further, in some embodiments, the method 800 may include a step 802 of receiving, using the communication device 1002, one or more second trading requests for trading the asset nonfungible tokens from one or more second user devices (such as one or more second user devices 1108) associated with the one or more second users. Further, the one or more second user devices may include computing devices, client devices, etc. Further, the method 800 may include a step 804 of generating, using the processing device 1004, one or more first prompts for acquiring the one or more first asset nonfungible tokens from the one or more second users. Further, the method 800 may include a step 806 of transmitting, using the communication device 1002, the one or more first prompts to the one or more second user devices. Further, the method 800 may include a step 808 of receiving, using the communication device 1002, one or more indications of the one or more first asset nonfungible tokens corresponding to the one or more first prompts from the one or more second user devices. Further, the identifying of the one or more first asset nonfungible tokens may be based on the one or more indications.

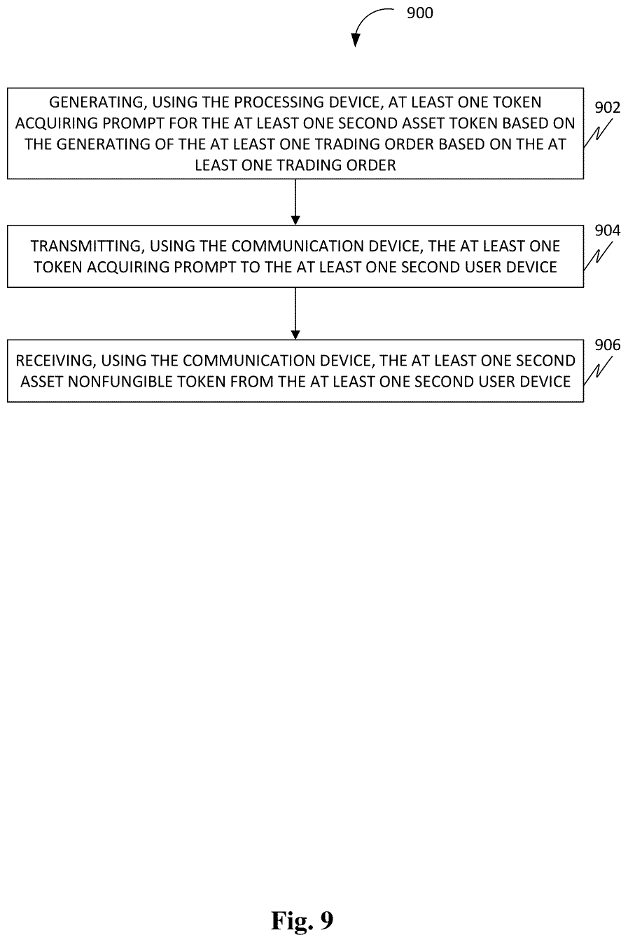

FIG. 9 illustrates a flowchart of a method 900 of facilitating preselling and provisioning of assets using nonfungible tokens, in accordance with some embodiments.

Further, the method 900 may include a step 902 of generating, using the processing device 1004, one or more token acquiring prompts for the one or more second asset tokens based on the generating of the one or more trading orders based on the one or more trading orders. Further, the method 900 may include a step 904 of transmitting, using the communication device 1002, the one or more token acquiring prompts to the one or more second user devices. Further, the method 900 may include a step 906 of receiving, using the communication device 1002, the one or more second asset nonfungible tokens from the one or more second user devices.

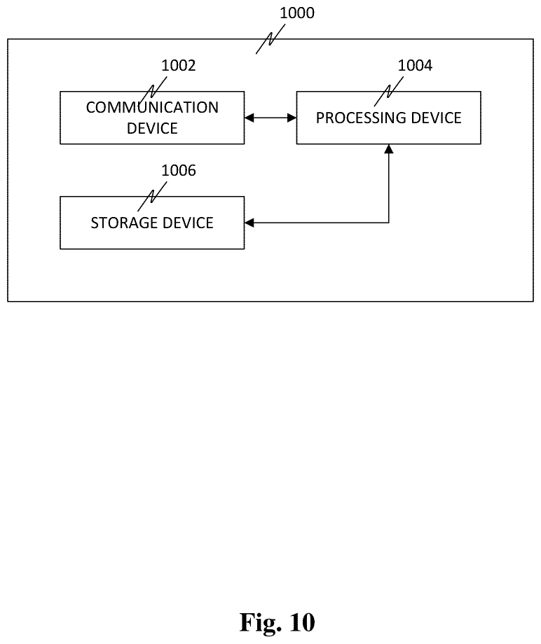

FIG. 10 illustrates a block diagram of a system 1000 of facilitating preselling and provisioning of assets using nonfungible tokens, in accordance with some embodiments.

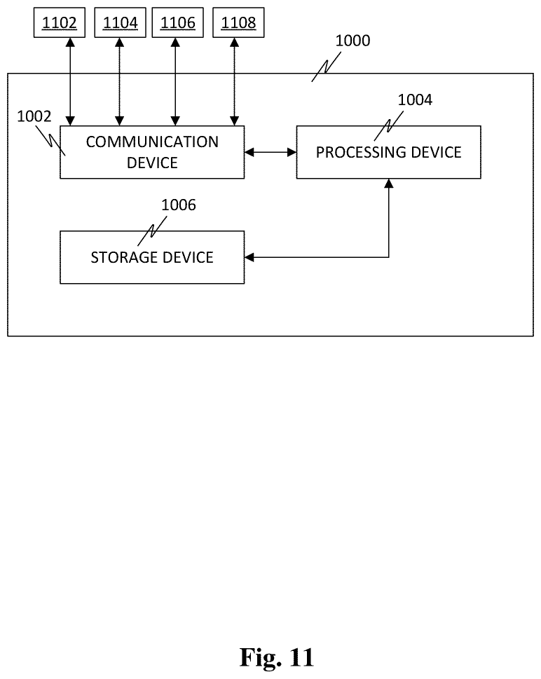

Accordingly, the system 1000 may include a communication device 1002. Further, the communication device 1002 may be configured for receiving a request for purchasing the assets from one or more user devices 1102 (as shown in FIG. 11) associated with one or more users. Further, the communication device 1002 may be configured for transmitting an asset data of a number of assets available to be pre-sold to the one or more users to the one or more user devices 1102. Further, the communication device 1002 may be configured for receiving one or more selections of one or more assets from the number of assets from the one or more user devices 1102. Further, the communication device 1002 may be configured for transmitting one or more purchase orders to the one or more user devices 1102. Further, the communication device 1002 may be configured for receiving one or more user payment data for the one or more payments of the one or more assets from the one or more user devices 1102. Further, the communication device 1002 may be configured for transmitting one or more asset nonfungible tokens to the one or more user devices 1102. Further, the system 1000 may include a processing device 1004 communicatively coupled with the communication device 1002. Further, the processing device 1004 may be configured for generating the one or more purchase orders for the one or more users based on the one or more selections of the one or more assets. Further, the one or more purchase orders may include one or more price information associated with one or more prices of the one or more assets and one or more prompts requesting one or more payments for the one or more assets. Further, the processing device 1004 may be configured for processing a transaction for the one or more assets using the one or more user payment data and the one or more purchase orders. Further, the processing device 1004 may be configured for generating one or more asset nonfungible token data corresponding to the one or more asset nonfungible tokens of the one or more assets based on the processing. Further, the one or more asset nonfungible tokens may guarantee the one or more users of the provisioning of the one or more assets up to a launch date for a sale of the one or more assets. Further, the system 1000 may include a storage device 1006 communicatively coupled with the processing device 1004. Further, the storage device 1006 may be configured for storing the one or more asset nonfungible token data to a distributed ledger.

In some embodiments, the processing device 1004 may be further configured for generating the one or more asset nonfungible tokens based on the processing and the one or more selections of the one or more assets. Further, the generating of the one or more asset nonfungible token data may be based on the generating of the one or more asset nonfungible tokens.

Further, in some embodiments, the one or more assets may include at least one physically unclonable function (PUF) device 1104 (as shown in FIG. 11). Further, the one or more PUF devices 1104 may be configured for generating one or more responses based on one or more stimulus to the one or more PUF devices 1104. Further, the communication device 1002 may be configured for receiving the one or more responses from the one or more PUF devices 1104. Further, the one or more responses may include one or more identifiers associated with the one or more PUF devices 1104. Further, the communication device 1002 may be configured for transmitting a result to the one or more user devices 1102. Further, the storage device 1006 may be configured for retrieving one or more expected responses expected from the one or more PUF devices 1104 based on the one or more identifiers. Further, the processing device 1004 may be configured for analyzing the one or more responses and the one or more expected responses. Further, the processing device 1004 may be configured for generating the result for the one or more assets based on the analyzing.

In some embodiments, the analyzing further includes comparing the one or more responses and the one or more expected responses using one or more machine learning models. Further, the processing device 1004 may be configured for determining a degree of match between the one or more responses and the one or more expected responses based on the comparing. Further, the generating of the result may be based on the determining of the degree of match.

Further, in some embodiments, the communication device 1002 may be configured for receiving one or more first trading requests for trading asset nonfungible tokens from one or more first user devices 1106 (as shown in FIG. 11) associated with one or more first users. Further, the communication device 1002 may be configured for transmitting one or more first asset nonfungible token data to the one or more first user devices 1106. Further, the communication device 1002 may be configured for receiving one or more trading orders from the one or more first user devices 1106. Further, the one or more trading orders may include one or more selections of one or more second asset nonfungible tokens from one or more first asset nonfungible tokens and at least one first user payment data associated with the one or more first users. Further, the communication device 1002 may be configured for transmitting the one or more second asset nonfungible tokens to the one or more first user devices 1106. Further, the processing device 1004 may be configured for initiating one or more trading sessions based on the one or more first trading requests. Further, the processing device 1004 may be configured for identifying the one or more first asset nonfungible tokens available to be traded by one or more second users based on the initiating and the one or more first trading requests. Further, the processing device 1004 may be configured for processing a transaction for the one or more second asset nonfungible tokens based on the one or more trading orders. Further, the storage device 1006 may be configured for retrieving the one or more first asset nonfungible token data of the one or more first asset nonfungible tokens based on the identifying.

In some embodiments, the processing device 1004 may be configured for generating one or more trading data for the one or more trading sessions based on the processing of the transaction for the one or more second asset nonfungible tokens. Further, the storage device 1006 may be configured for storing the one or more trading data of the one or more trading sessions in the distributed ledger.

Further, in some embodiments, the storage device 1006 may be configured for retrieving one or more historic trading data associated with one or more historic trading sessions from the distributed ledger. Further, the one or more historic trading data may be associated with the trading of one or more of two or more asset nonfungible tokens. Further, the storage device 1006 may be configured for storing an actual price for one or more of the two or more asset nonfungible tokens. Further, the processing device 1004 may be configured for analyzing the one or more historic trading data using one or more first machine learning models. Further, the processing device 1004 may be configured for discovering the actual price for one or more of the two or more asset nonfungible tokens based on the analyzing of the one or more historic trading data.

In some embodiments, the two or more asset nonfungible tokens may include the one or more second asset nonfungible tokens. Further, the processing device 1004 may be configured for analyzing the one or more trading data associated with the one or more trading sessions using the one or more first machine learning models. Further, the discovering of the actual price for one or more of the two or more asset nonfungible tokens may be based on the analyzing of the one or more trading data.

Further, in some embodiments, the communication device 1002 may be configured for receiving one or more second trading requests for trading the asset nonfungible tokens from one or more second user devices 1108 (as shown in FIG. 11) associated with the one or more second users. Further, the communication device 1002 may be configured for transmitting one or more first prompts to the one or more second user devices 1108. Further, the communication device 1002 may be configured for receiving one or more indications of the one or more first asset nonfungible token corresponding to the one or more first prompts from the one or more second user devices 1108. Further, the identifying of the one or more first asset nonfungible tokens may be based on the one or more indications. Further, the processing device 1004 may be configured for generating the one or more first prompts for acquiring the one or more first asset nonfungible tokens from the one or more second users.

Further, in some embodiments, the processing device 1004 may be configured for generating one or more token acquiring prompts for the one or more second asset tokens based on the generating of the one or more trading orders based on the one or more trading orders. Further, the communication device 1002 may be configured for transmitting the one or more token acquiring prompts to the one or more second user devices 1108. Further, the communication device 1002 may be configured for receiving the one or more second asset nonfungible tokens from the one or more second user devices 1108.

FIG. 11 illustrates a block diagram of the system 1000 of facilitating preselling and provisioning of assets using nonfungible tokens, in accordance with some embodiments.

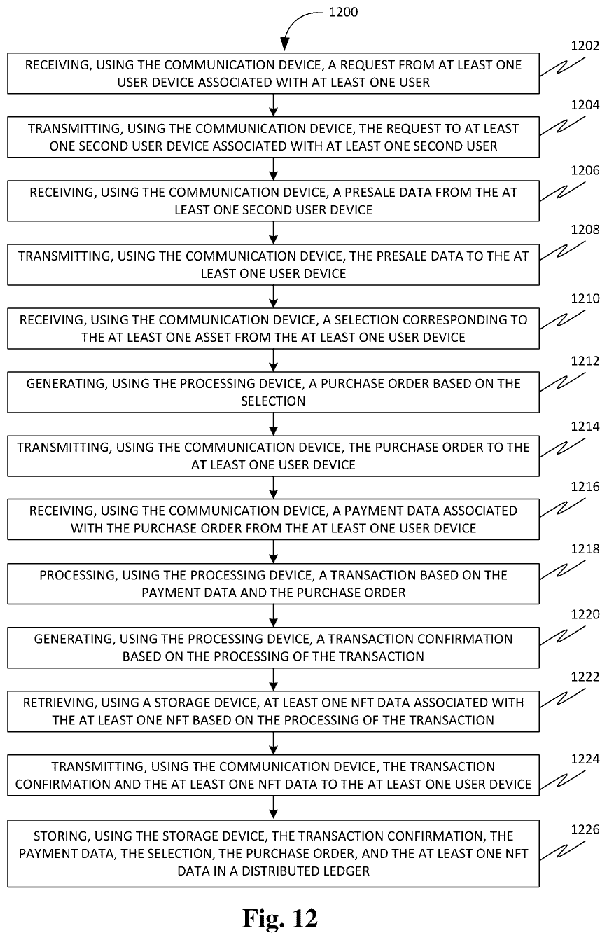

FIG. 12 is a flow chart of a method 1200 for facilitating selling assets using non-fungible tokens, in accordance with some embodiments. Accordingly, at 1202, the method 1200 may include receiving, using a communication device, a request from at least one user device associated with at least one user. Further, the request may indicate that the at least one user may want to purchase the at least one asset using at least one non-fungible token. Further, the at least one user may include an individual, an institution, and an organization that may want to purchase the at least one asset. Further, the at least one user device may include a desktop, a mobile, a tablet, a laptop, a personal computer, and so on. Further, the request may include a user data. Further, the user data may include a user name, a user contact address, an email address, a phone number, etc. Further, the at least one asset may include a product, a service, a ticket, etc. Further, the at least one asset may be characterized by a limited-edition stock. Further, in an instance, the at least one asset may include a sports shoe. Further, in an instance, the at least one asset may include a concert ticket, a movie ticket, etc.

Further, at 1204, the method 1200 may include transmitting, using the communication device, the request to at least one second user device associated with at least one second user.

Further, at 1206, the method 1200 may include receiving, using the communication device, a presale data from the at least one second user device. Further, the at least one second user may include an individual, an institution, and an organization that may want to provide (and/or sell) the at least one asset using the at least one non-fungible token (NFT). Further, the at least one second user device may include a desktop, a mobile, a tablet, a laptop, a personal computer, and so on. Further, the presale data may include an information associated with the least one asset. Further, the presale data may be associated with a presale of the at least one asset before the launch of the at least one asset. Further, the information may include a markup price of the at least one asset. Further, the information may include a time period of the presale. Further, the at least one asset may include a product, a service, a ticket, etc. Further, in an instance, the information associated with the product may include a product name, a product image, a product color, a product price, a product size, etc. Further, in an instance, the information associated with the service may include a service name, a service duration, a service price, etc. Further, the at least one second user may provide (or manufacture) the at least one asset. Further, in an instance, the at least one second owner may include a brand such as Nike™. Further, in an instance, the information may include a shoe size, a shoe image, a shoe price, a shoe color, etc.

Further, at 1208, the method 1200 may include transmitting, using the communication device, the presale data to the at least one user device.

Further, at 1210, the method 1200 may include receiving, using the communication device, a selection corresponding to the at least one asset from the at least one user device. Further, in an instance, the selection may include a black colored size nine men sports shoe from Nike™ that the at least one user may want to purchase.

Further, at 1212, the method 1200 may include generating, using a processing device, a purchase order based on the selection. Further, the purchase order may include the information and a final price of the at least one asset selected by the at least one user.

Further, at 1214, the method 1200 may include transmitting, using the communication device, the purchase order to the at least one user device.

Further, at 1216, the method 1200 may include receiving, using the communication device, a payment data associated with the purchase order from the at least one user device. Further, the payment data may include payment details associated with at least one payment mode. Further, the at least one payment mode may include NEFT, IMPS, UPI, credit card payment, debit card payment, etc. Further, in an instance, the payment data may include bank account credentials, credit card credentials, debit card credentials, UPI id credentials, etc.

Further, at 1218, the method 1200 may include processing, using the processing device, a transaction based on the payment data and the purchase order.

Further, at 1220, the method 1200 may include generating, using the processing device, a transaction confirmation based on the processing of the transaction. Further, the transaction confirmation may indicate receiving of a payment corresponding to a price of the at least one asset from the at least one user for purchasing the at least one asset.

Further, at 1222, the method 1200 may include retrieving, using a storage device, at least one NFT data associated with the at least one NFT based on the processing of the transaction. Further, the at least one NFT data may include the information of the at least one asset. Further, the at least one NFT data may include a blockchain address and a unique NFT identifier.

Further, at 1224, the method 1200 may include transmitting, using the communication device, the transaction confirmation and the at least one NFT data to the at least one user device.

Further, at 1226, the method 1200 may include storing, using the storage device, the transaction confirmation, the payment data, the selection, the purchase order, and the at least one NFT data in a distributed ledger.

Further, in some embodiments, the at least one NFT data may include at least one multimedia asset. Further, the at least one multimedia content may include an audio, a video, an audio video, an image, etc. Further, the method 1200 may include receiving, using the communication device, a device identifier from the at least one user device. Further, the device identifier may be associated with at least one presentation device configured for displaying the at least one multimedia asset. Further, the at least one presentation device may include the at least one user device. Further, the method 1200 may include analyzing, using the processing device, the device identifier for generating a device authentication status. Further, the device authentication status may authenticate the at least one presentation device for displaying the at least one multimedia asset. Further, the method 1200 may include associating, using the processing device, the at least one presentation device to the at least one user. Further, the transmitting of the at least one NFT data may be based on the device authentication status.

Further, in some embodiments, the at least one asset may include a physical unclonable function (PUF) device. Further, PUF provides physically defined “digital fingerprint” output (response) that serves as a unique identifier. Further, the PUF may be a physical entity embodied in a physical structure (such as the at least one asset). Further, the PUF may implement a challenge-response authentication to authenticate the at least one asset. Further, the method 1200 may include receiving, using the communication device, at least one PUF response from the PUF device. Further, the PUF device may generate the at least one PUF response based on interacting with at least one physical stimulus (or challenge information). Further, the method 1200 may include retrieving, using the storage device, at least one response corresponding to the at least one physical stimulus from the distributed ledger. Further, the method 1200 may include comparing, using the processing device, the at least one PUF response and the at least one response. Further, the method 1200 may include generating, using the processing device, a result based on the comparing of the at least one PUF response and the at least one response. Further, the method 1200 may include transmitting, using the communication device, the result to the at least one user device. Further, the result may reflect authenticity of the at least one asset and inform the at least one user about the authenticity of the at least one asset. Further, the result may be characterized by a degree of match that may reflect the authenticity of the at least one asset.

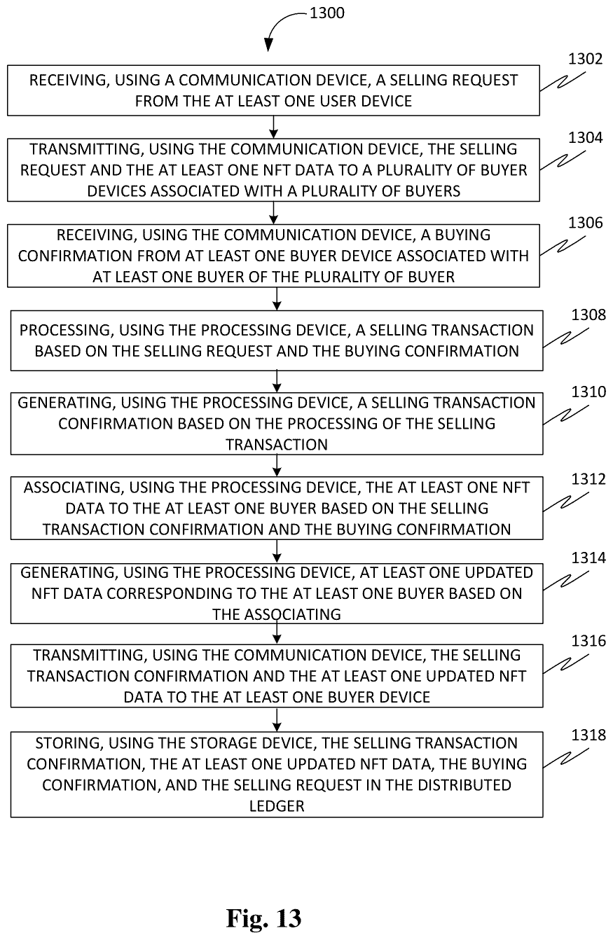

FIG. 13 is a flow chart of a method 1300 for facilitating selling assets using non-fungible tokens, in accordance with some embodiments. Accordingly, at 1302, the method 1300 may include receiving, using the communication device, a selling request from the at least one user device. Further, the selling request may indicate that the at least one user may want to sell the at least one asset. Further, the selling request may include a selling price at which the at least one user may want to sell the at least one asset.

Further, at 1304, the method 1300 may include transmitting, using the communication device, the selling request and the at least one NFT data to a plurality of buyer devices associated with a plurality of buyers. Further, the plurality of buyers may include an individual, an institution, and an organization that may want to purchase the at least one asset from the at least one user in a secondary market. Further, the plurality of buyers and the at least one user may be connected via peer-to-peer (P2P) connections in the distributed ledger.

Further, at 1306, the method 1300 may include receiving, using the communication device, a buying confirmation from at least one buyer device associated with at least one buyer of the plurality of buyers. Further, the buying confirmation may indicate that the at least one buyer may want to purchase the at least one asset from the at least one user. Further, the buying confirmation may include buyer data such as buyer name, buyer identity card, buyer address, buyer contact number, and so on. Further, the buying confirmation may include a buying payment information comprising payment details associated with at least one payment mode. Further, the at least one payment mode may include NEFT, IMPS, UPI, credit card payment, debit card payment, etc. Further, in an instance, the buying payment information may include bank account credentials, credit card credentials, debit card credentials, UPI ID credentials, etc.

Further, at 1308, the method 1300 may include processing, using the processing device, a selling transaction based on the selling request and the buying confirmation.

Further, at 1310, the method 1300 may include generating, using the processing device, a selling transaction confirmation based on the processing of the selling transaction.

Further, at 1312, the method 1300 may include associating, using the processing device, the at least one NFT data to the at least one buyer based on the selling transaction confirmation and the buying confirmation.

Further, at 1314, the method 1300 may include generating, using the processing device, at least one updated NFT data corresponding to the at least one buyer based on the associating. Further, the at least one updated NFT data may include the information of the at least one asset that may be associated with the at least one buyer.

Further, at 1316, the method 1300 may include transmitting, using the communication device, the selling transaction confirmation and the at least one updated NFT data to the at least one buyer device.

Further, at 1318, the method 1300 may include storing, using the storage device, the selling transaction confirmation, the at least one updated NFT data, the buying confirmation, and the selling request in the distributed ledger.

Further, in some embodiments, the method 1300 may include retrieving, using the processing device, a first smart contract based on the associating. Further, the method 1300 may include executing, using the processing device, the first smart contract. Further, the first smart contract may be configured for authenticating that the at least one buyer had bought the at least one asset. Further, the method 1300 may include encrypting, using the processing device, the at least one updated NFT data using a data key. Further, the method 1300 may include generating, using the processing device, at least one encrypted NFT data based on the encrypting. Further, the method 1300 may include transmitting, using the communication device, the at least one encrypted NFT data and the data key to the at least one buyer device. Further, the at least one buyer may use the data key to decrypt the at least one encrypted NFT data. Further, the method 1300 may include storing, using the storage device, the at least one encrypted data and the data key in the distributed ledger.

Further, in some embodiments, the method 1300 may include retrieving, using the storage device, a second smart contract based on the receiving of the selling request from the distributed ledger. Further, the method 1300 may include executing, using the processing device, the second smart contract based on the retrieving of the second smart contract. Further, the second smart contract may allow authentication of the at least one user. Further, the authentication may include confirming ownership of the at least one asset. Further, the method 1300 may include generating, using the processing device, an authentication notification associated with the at least one asset based on the executing of the second smart contract. Further, the transmitting of the selling request and the at least one NFT data to the plurality of buyer devices may be based on the authentication notification. Further, the method 1300 may include storing, using the storage device, the authentication notification in the distributed ledger.

Further, in some embodiments, the method 1300 may include transmitting, using the communication device, at least one of the selling request, the selling transaction confirmation, and the buying confirmation to the at least one second user device.

Further, in some embodiments, the method 1300 may include receiving, using the communication device, an asset analytic request from the at least one second user device. Further, the asset analytic request may indicate that the at least one second user may want to view ownership details (such as price, owner details, etc.) of the at least one asset. Further, the method 1300 may include retrieving, using the storage device, the presale data, the transaction confirmation, the selling request, the selling transaction confirmation, and the buying confirmation from the distributed ledger. Further, the method 1300 may include analyzing, using the processing device, at least one of the presale data, the transaction confirmation, the selling request, the selling transaction confirmation, and the buying confirmation using at least one machine learning model. Further, the at least one machine learning model may be based on at least one machine learning algorithm. Further, the method 1300 may include generating, using the processing device, an asset analytic data based on the analyzing. Further, the asset analytic data may be associated with the at least one asset. Further, the asset analytic data may provide insight into a price and a demand of the at least one asset in the secondary market. Further, in an instance, the at least one second user may know if the at least one asset was overpriced, underpriced, or perfectly priced at a price finalized by the at least one second user. Further, the method 1300 may include transmitting, using the communication device, the asset analytic data to the at least one second user device. Further, the method 1300 may include storing, using the storage device, the asset analytic data in the distributed ledger. Further, the asset analytic data may allow the at least one second user in discovering a price of the at least one second asset in the secondary market. Further, this may allow the at least one second user to capture trading of the at least one asset in the secondary market.

Although the invention has been explained in relation to its preferred embodiment, it is to be understood that many other possible modifications and variations can be made without departing from the spirit and scope of the invention as hereinafter claimed.

1. A method of facilitating preselling and provisioning of assets using nonfungible tokens, wherein the method comprises:
receiving, using a communication device, a request for purchasing the assets from at least one user device associated with at least one user;
transmitting, using the communication device, an asset data of a number of assets available to be pre-sold to the at least one user to the at least one user device;
receiving, using the communication device, at least one selection of at least one asset from the number of assets from the at least one user device;
generating, using a processing device, at least one purchase order for the at least one user based on the at least one selection of the at least one asset, wherein the at least one purchase order comprises at least one price information associated with at least one price of the at least one asset and at least one prompt requesting at least one payment for the at least one asset;
transmitting, using the communication device, the at least one purchase order to the at least one user device;
receiving, using the communication device, at least one user payment data for the at least one payment of the at least one asset from the at least one user device;
processing, using the processing device, a transaction for the at least one asset using the at least one user payment data and the at least one purchase order;
generating, using the processing device, at least one asset nonfungible token data corresponding to at least one asset nonfungible token of the at least one asset based on the processing, wherein the at least one asset nonfungible token guarantees the at least one user of the provisioning of the at least one asset up to a launch date for a sale of the at least one asset;
transmitting, using the communication device, the at least one asset nonfungible token to the at least one user device; and
storing, using a storage device, the at least one asset nonfungible token data to a distributed ledger.

2. The method of claim 1 further comprising generating, using the processing device, the at least one asset nonfungible token based on the processing and the at least one selection of the at least one asset, wherein the generating of the at least one asset nonfungible token data is further based on the generating of the at least one asset nonfungible token.

3. The method of claim 1 wherein the at least one asset comprises at least one physically unclonable function (PUF) device, wherein the at least one PUF device is configured for generating at least one response based on at least one stimulus to the at least one PUF device, wherein the method further comprises:
receiving, using the communication device, the at least one response from the at least one PUF device, wherein the at least one response comprises at least one identifier associated with the at least one PUF device;
retrieving, using the storage device, at least one expected response expected from the at least one PUF device based on the at least one identifier;
analyzing, using the processing device, the at least one response and the at least one expected response;
generating, using the processing device, a result for the at least one asset based on the analyzing; and
transmitting, using the communication device, the result to the at least one user device.

4. The method of claim 3 wherein the analyzing further comprises comparing the at least one response and the at least one expected response using at least one machine learning model, wherein the method further comprises determining, using the processing device, a degree of match between the at least one response and the at least one expected response based on the comparing, wherein the generating of the result is further based on the determining of the degree of match.

5. The method of claim 1 further comprises:
receiving, using the communication device, at least one first trading request for trading asset nonfungible tokens from at least one first user device associated with at least one first user;
initiating, using the processing device, at least one trading session based on the at least one first trading request;
identifying, using the processing device, at least one first asset nonfungible token available to be traded by at least one second user based on the initiating and the at least one first trading request;
retrieving, using the storage device, at least one first asset nonfungible token data of the at least one first asset nonfungible token based on the identifying;
transmitting, using the communication device, the at least one first asset nonfungible token data to the at least one first user device;
receiving, using the communication device, at least one trading order from the at least one first user device, wherein the at least one trading order comprises at least one selection of at least one second asset nonfungible token from the at least one first asset nonfungible token and at least one first user payment data associated with the at least one first user;
processing, using the processing device, a transaction for the at least one second asset nonfungible token based on the at least one trading order; and
transmitting, using the communication device, the at least one second asset nonfungible token to the at least one first user device.

6. The method of claim 5 further comprises:
generating, using the processing device, at least one trading data for the at least one trading session based on the processing of the transaction for the at least one second asset nonfungible token; and
storing, using the storage device, the at least one trading data of the at least one trading session in the distributed ledger.

7. The method of claim 6 further comprises:
retrieving, using the storage device, at least one historic trading data associated with at least one historic trading session from the distributed ledger, wherein the at least one historic trading data is associated with the trading of at least one of a plurality of asset nonfungible tokens;
analyzing, using the processing device, the at least one historic trading data using at least one first machine learning model;
discovering, using the processing device, an actual price for at least one of the plurality of asset nonfungible tokens based on the analyzing of the at least one historic trading data; and
storing, using the storage device, the actual price for at least one of the plurality of asset nonfungible tokens.

8. The method of claim 7, wherein the plurality of asset nonfungible tokens comprises the at least one second asset nonfungible token, wherein the method further comprises analyzing, using the processing device, the at least one trading data associated with the at least one trading session using the at least one first machine learning model, wherein the discovering of the actual price for at least one of the plurality of asset nonfungible tokens is further based on the analyzing of the at least one trading data.

9. The method of claim 5 further comprises:
receiving, using the communication device, at least one second trading request for trading the asset nonfungible tokens from at least one second user device associated with the at least one second user;
generating, using the processing device, at least one first prompt for acquiring the at least one first asset nonfungible token from the at least one second user;
transmitting, using the communication device, the at least one first prompt to the at least one second user device; and
receiving, using the communication device, at least one indication of the at least one first asset nonfungible token corresponding to the at least one first prompt from the at least one second user device, wherein the identifying of the at least one first asset nonfungible token is further based on the at least one indication.

10. The method of claim 5 further comprises:
generating, using the processing device, at least one token acquiring prompt for the at least one second asset token based on the generating of the at least one trading order based on the at least one trading order;
transmitting, using the communication device, the at least one token acquiring prompt to the at least one second user device; and
receiving, using the communication device, the at least one second asset nonfungible token from the at least one second user device.

11. A system for facilitating preselling and provisioning of assets using nonfungible tokens, the system comprising:
a communication device configured for:
receiving a request for purchasing the assets from at least one user device associated with at least one user;
transmitting an asset data of a number of assets available to be pre-sold to the at least one user to the at least one user device;
receiving at least one selection of at least one asset from the number of assets from the at least one user device;
transmitting at least one purchase order to the at least one user device;
receiving at least one user payment data for the at least one payment of the at least one asset from the at least one user device; and
transmitting at least one asset nonfungible token to the at least one user device;
a processing device communicatively coupled with the communication device, wherein the processing device is configured for:
generating the at least one purchase order for the at least one user based on the at least one selection of the at least one asset, wherein the at least one purchase order comprises at least one price information associated with at least one price of the at least one asset and at least one prompt requesting at least one payment for the at least one asset;
processing a transaction for the at least one asset using the at least one user payment data and the at least one purchase order; and
generating at least one asset nonfungible token data corresponding to the at least one asset nonfungible token of the at least one asset based on the processing, wherein the at least one asset nonfungible token guarantees the at least one user of the provisioning of the at least one asset up to a launch date for a sale of the at least one asset; and
a storage device communicatively coupled with the processing device, wherein the storage device is configured for storing the at least one asset nonfungible token data to a distributed ledger.

12. The system of claim 11, wherein the processing device is further configured for generating the at least one asset nonfungible token based on the processing and the at least one selection of the at least one asset, wherein the generating of the at least one asset nonfungible token data is further based on the generating of the at least one asset nonfungible token.

13. The system of claim 11, wherein the at least one asset comprises at least one physically unclonable function (PUF) device, wherein the at least one PUF device is configured for generating at least one response based on at least one stimulus to the at least one PUF device, wherein the communication device is further configured for:
receiving the at least one response from the at least one PUF device, wherein the at least one response comprises at least one identifier associated with the at least one PUF device; and
transmitting a result to the at least one user device, wherein the storage device is further configured for retrieving at least one expected response expected from the at least one PUF device based on the at least one identifier, wherein the processing device is further configured for:
analyzing the at least one response and the at least one expected response; and
generating the result for the at least one asset based on the analyzing.

14. The system of claim 13 wherein the analyzing further comprises comparing the at least one response and the at least one expected response using at least one machine learning model, wherein the processing device is further configured for determining a degree of match between the at least one response and the at least one expected response based on the comparing, wherein the generating of the result is further based on the determining of the degree of match.

15. The system of claim 11, wherein the communication device is further configured for:
receiving at least one first trading request for trading asset nonfungible tokens from at least one first user device associated with at least one first user;
transmitting at least one first asset nonfungible token data to the at least one first user device;
receiving at least one trading order from the at least one first user device, wherein the at least one trading order comprises at least one selection of at least one second asset nonfungible token from at least one first asset nonfungible token and at least one first user payment data associated with the at least one first user; and
transmitting the at least one second asset nonfungible token to the at least one first user device, wherein the processing device is further configured for:
initiating at least one trading session based on the at least one first trading request;
identifying the at least one first asset nonfungible token available to be traded by at least one second user based on the initiating and the at least one first trading request; and
processing a transaction for the at least one second asset nonfungible token based on the at least one trading order, wherein the storage device is further configured for retrieving the at least one first asset nonfungible token data of the at least one first asset nonfungible token based on the identifying.

16. The system of claim 15, wherein the processing device is further configured for generating at least one trading data for the at least one trading session based on the processing of the transaction for the at least one second asset nonfungible token, wherein the storage device is further configured for storing the at least one trading data of the at least one trading session in the distributed ledger.

17. The system of claim 16, wherein the storage device is further configured for:
retrieving at least one historic trading data associated with at least one historic trading session from the distributed ledger, wherein the at least one historic trading data is associated with the trading of at least one of a plurality of asset nonfungible tokens; and
storing an actual price for at least one of the plurality of asset nonfungible tokens, wherein the processing device is further configured for:
analyzing the at least one historic trading data using at least one first machine learning model; and
discovering the actual price for at least one of the plurality of asset nonfungible tokens based on the analyzing of the at least one historic trading data.

18. The system of claim 17, wherein the plurality of asset nonfungible tokens comprises the at least one second asset nonfungible token, wherein the processing device is further configured for analyzing the at least one trading data associated with the at least one trading session using the at least one first machine learning model, wherein the discovering of the actual price for at least one of the plurality of asset nonfungible tokens is further based on the analyzing of the at least one trading data.

19. The system of claim 15, wherein the communication device is further configured for:
receiving at least one second trading request for trading the asset nonfungible tokens from at least one second user device associated with the at least one second user;
transmitting at least one first prompt to the at least one second user device; and
receiving at least one indication of the at least one first asset nonfungible token corresponding to the at least one first prompt from the at least one second user device, wherein the identifying of the at least one first asset nonfungible token is further based on the at least one indication, wherein the processing device is further configured for generating the at least one first prompt for acquiring the at least one first asset nonfungible token from the at least one second user.

20. The system of claim 15, wherein the processing device is further configured for generating at least one token acquiring prompt for the at least one second asset token based on the generating of the at least one trading order based on the at least one trading order, wherein the communication device is further configured for:
transmitting the at least one token acquiring prompt to the at least one second user device; and
receiving the at least one second asset nonfungible token from the at least one second user device.
